(19) United States
(12) Patent Application Publication
(10) Pub. No.: US 2025/0196335 A1
(43) Pub. Date: Jun. 19, 2025

(54) PROCESS AND DEVICE FOR THE AUTOMATED HANDLING OF FLEXIBLE LAMINAR MATERIALS

(71) Applicants: ROBOT SYSTEM AUTOMATION S.R.L., Casciana Terme Lari (IT); BARNINI S.R.L., Castelfranco di Sotto (IT)

(72) Inventors: Tommaso LANDI, Pisa (IT); Tommaso SESTINI, Pontedera (IT); Marco MINUTILLO, Bientina (IT); Lorenzo SIMONI, Santa Croce sull'Arno (IT); Andrea ORLANDI, Castelfranco di Sotto (IT); Matteo SIMONI, San Miniato (IT)

(21) Appl. No.: 18/843,319

(22) PCT Filed: Mar. 7, 2023
(86) PCT No.: PCT/IT2023/050064

§ 371 Date: Sep. 3, 2024

(30) Foreign Application Priority Data
Mar. 8, 2022 (IT) 102022000004319
Sep. 19, 2022 (IT) 202022000003786

(51) Int. Cl. B25J 9/16; B25J 13/08; B65G 47/61

(52) U.S. Cl. CPC B25J 9/1612; B25J 13/082; B65G 47/61

(57) ABSTRACT

Device and process for the automated handling of flexible laminar materials, in which are operated the picking of a flexible material (P) by means of a picking member (34) which engages a first portion of the flexible material, the handling of the picking member along a predefined trajectory for placing a second free portion (LP) of the flexible material on a deposition surface (2) of the flexible materials, in the deposition of each flexible material (P) a friction force develops between the flexible material and said surface, and the second portion of the flexible material (P) is suspended from the pick-up member and, following the deposition of said free portion of the flexible material at the deposition point (PD), the pick-up member exerts on the flexible material (P) a distension force (FD) of a lower magnitude than said friction force (FA) while the flexible material is positioned on said surface with a controlled release speed.

The present invention relates to a process and a device for the automated handling of flexible laminar materials.

In particular, although not exclusively, the present invention finds advantageous application in the handling of animal hides subjected to tanning processes.

It is known that the tanning process comprises several chemical and mechanical processing phases, intended to transform animal hides into products having physical-mechanical characteristics which make them suitable for use in many sectors, including the production of clothing, footwear and furniture.

Conventionally, the tanning process is divided into two main phases. In a first phase, the hides are treated with aqueous solutions of various chemical products and subjected to mechanical operations of various kinds. In a second phase, chemical, mechanical or combined finishing treatments are carried out on dry hides, the purpose of which is substantially to improve or modify their appearance or hand. Before finishing, the hides are dehydrated in order to favor their drying and the loss of any unpleasant odors generated by the chemical tanning phases.

Many phases of the tanning process are still performed manually, in particular the phases which require the positioning of the hides according to a predefined arrangement with respect to the operating units used for the treatment of the hides themselves.

The extensive use of manual handling of the hides is mainly due to the variability of numerous factors, including:
variability of shapes and sizes of the hides to be handled;
variability of thickness and type of hides;
variability of the supports from which the hides are too be picked up (such as pallets, overhead conveyors, so-called horses, drying racks);
process speed;
methods for positioning the hides on the supports: in many cases the hides do not arrive at the treatment units in a constant order, but for process reasons they can be stacked in such a way that each hide has the grain side in contact with the grain side of the underlying hide which, consequently, is oriented in the opposite direction.

Similar drawbacks can arise, more generally, in processes which require the handling of flexible materials of a nature other than animal skins or hides.

Examples of devices for handling flexible laminar materials are disclosed in JP5145606B2 and SU1377298A1.

JP5145606B2 discloses, in particular, a gripping system consisting of a pair of grippers for gripping the flexible material to be transported and placed on the target surface on a side; the reciprocal distance between the two grippers, which are positioned at the two ends of the gripped side of the material, allows the material to be kept transversally stretched during its transport between the gripping surface and the destination surface. The controlled speed with which the system deposits the material on the target surface, while advancing along the same to facilitate spreading, combined with the progressive translation of the gripping system downwards, approaching the target surface, allow the gradual support of the material, eventually favoring its complete release, without particular wrinkles or creases on the basis of. However, due to its gripping characteristic, the system is not suitable for handling delicate materials, such as for example certain types of soft or thin leathers, considering that these grippers would inevitably leave evident marks on both sides of the material, at the gripping position, that would alter its quality.

SU1377298A1 describes a different handling system for flexible materials in which the material, in this case, is wound around a cylinder that rotates around its axis until generating the complete winding, in the form of a reel, of the material on the cylinder. The start of the winding is allowed by a slot inside said cylinder which allows one side of the material to be held inside, to block it, so as to allow the winding of the remaining material (without this slipping away). Said cylinder, once the wrapping of the material has been completed, translates along the surface on which it is to be released, and progressively and simultaneously rotates, in a controlled way, to allow the material to be deposited on the target surface. Also this gripping system inevitably exerts unwanted pressure on both sides of the material it has to transport (on the gripping side in the slot), leaving marks and, among other things, also causing unwanted rubbing along the entire profile of the material being wound, that is unacceptable in terms of quality, for example in the case of fine leathers.

An object of the present invention is therefore to propose a method and a device which allow to favor an increase in automation in the handling of flexible materials in general through methods and devices for transporting flexible materials which do not compromise their quality.

Another object of the present invention is to propose said method and said device capable, in particular, of not leaving grip marks on the surfaces of said flexible materials.

Another object of the present invention is to propose said method and said device in particular, although not exclusively, for handling animal hides in tanning processes.

A further object of the present invention is to propose a method and a device which allow to implement an effective technique for positioning the flexible materials in an extended position on surfaces of various types, both fixed and movable.

A further object of the present invention is to provide a system which allows to facilitate the automation of the picking up operations of the hides from the hangers of the overhead conveyors by the automatic manipulators.

This result has been achieved, in accordance with the present invention, by means of the technical solutions having the characteristics indicated in the independent claims. Other features of the present invention are the object of the dependent claims.

Thanks to the present invention, it is possible to automate fundamental handling phases of flexible materials in general, and in particular of animal hides in the tanning process, with advantages both in terms of productivity, in terms of risk reduction for the safety and health of the operators, and reduction of errors in the hide positioning phases compared to entirely manual procedures, and in terms of preservation of the materials to be handled, that is not altered by the handling and transportation process.

Furthermore, the operating procedures implemented in accordance with the present invention allow a correct handling of the flexible materials regardless of their shape, size, thickness and type and regardless of the type of support on which the materials to be treated are arranged.

In addition, the present invention allows the flexible materials to be positioned according to a correctly spread configuration on the target surfaces intended to receive them.

These and further advantages and characteristics of the present invention will be more and better understood by any person skilled in the art thanks to the following description and the annexed drawings, provided by way of example but not to be considered in a limiting sense, in which:

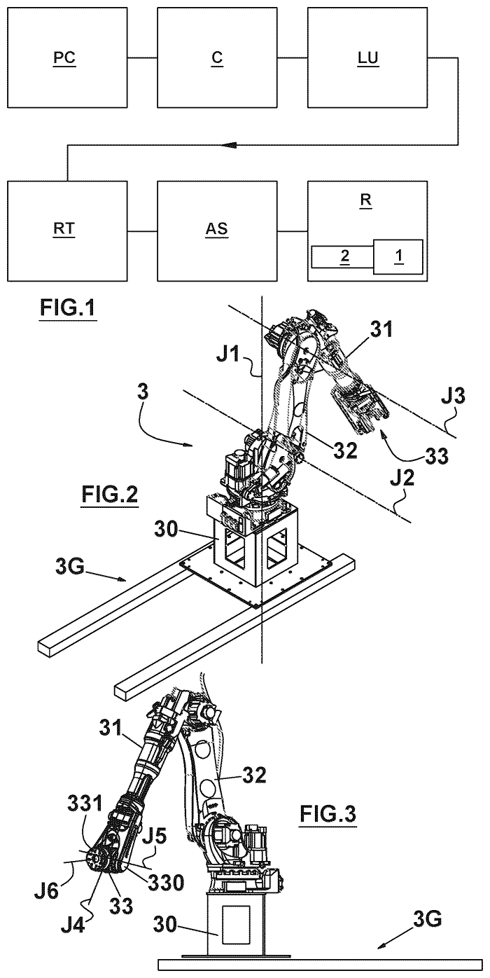

FIG. 1 is a simplified block diagram illustrating a possible layout of a plant for processing animal hides in which is provided a hides treatment area equipped with a device in accordance with the present invention;

FIGS. 2-3 show two perspective views of an industrial robot usable for realizing a device according to the invention;

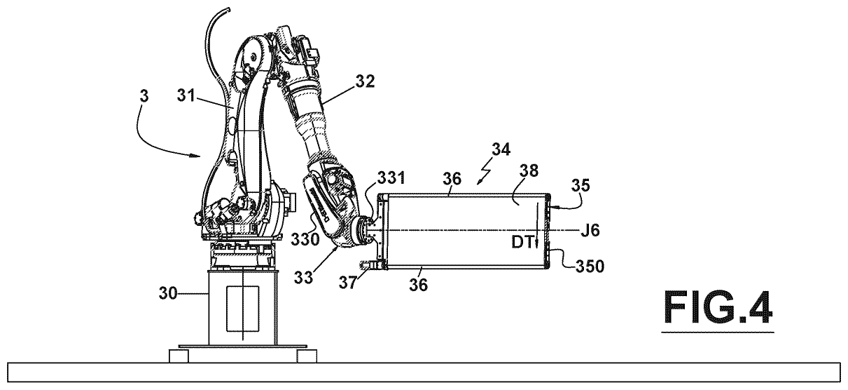

FIG. 4 shows the industrial robot of FIGS. 2-3 provided with a tool (34) for picking up and transporting the hides according to a possible embodiment in accordance with the present invention;

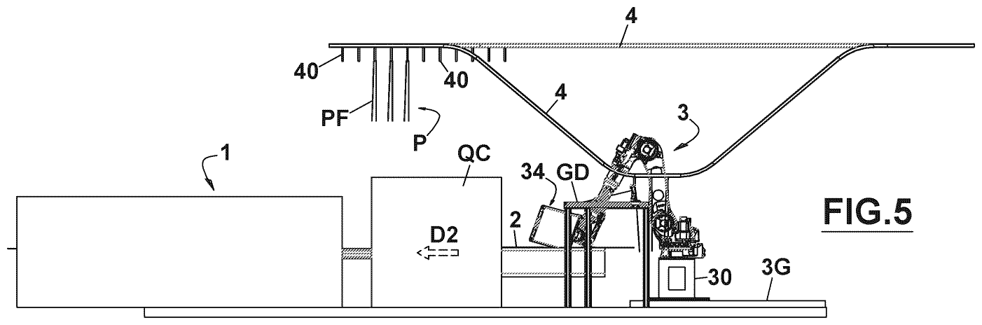

FIG. 5 represents a schematic side view of an overhead conveyor for transporting hides in a plant provided with a device in accordance with the present invention;

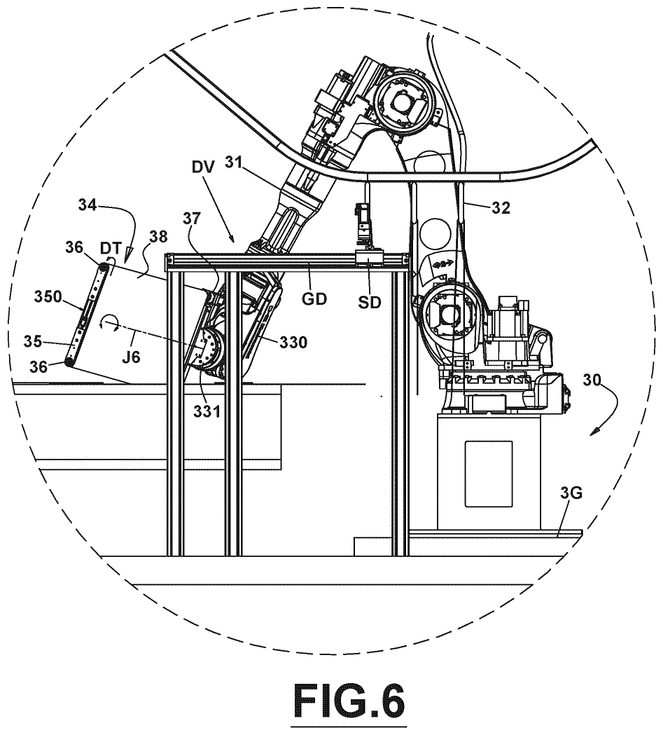

FIG. 6 is a detail of FIG. 5;

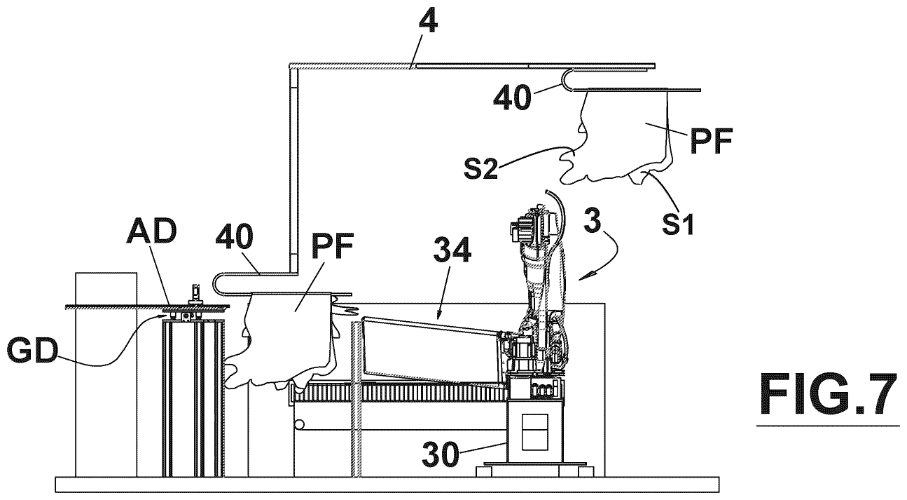

FIG. 7 shows a schematic partial side view of an overhead conveyor for transporting hides in a plant provided with a device in accordance with the present invention;

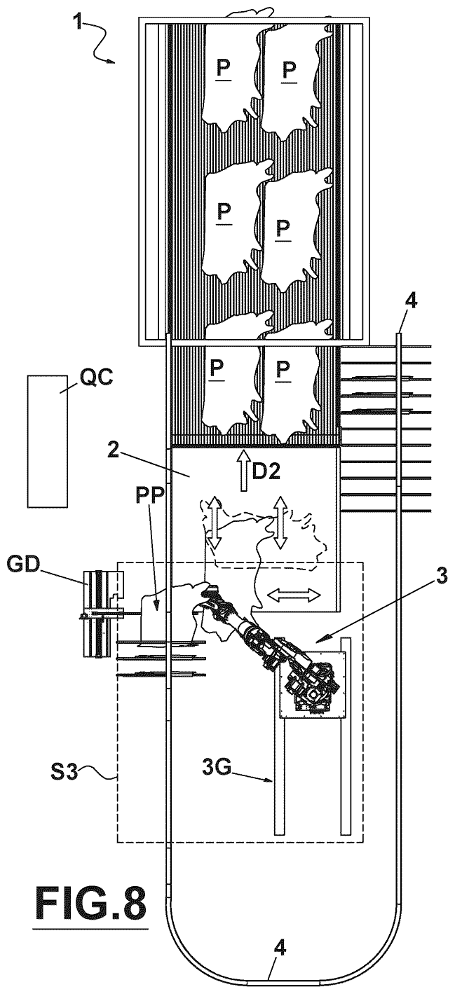

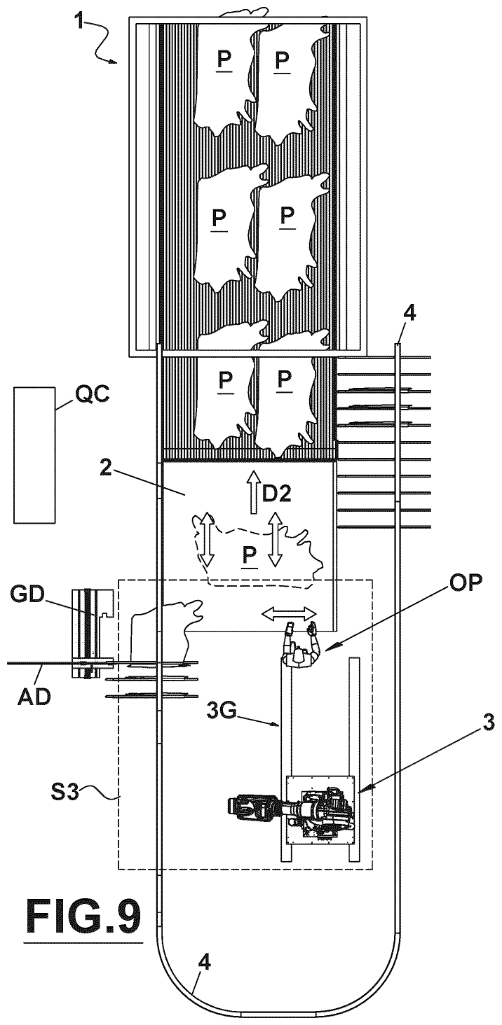

FIGS. 8-9 are two top views of the plant in FIG. 5 with the industrial robot (3) in two different positions;

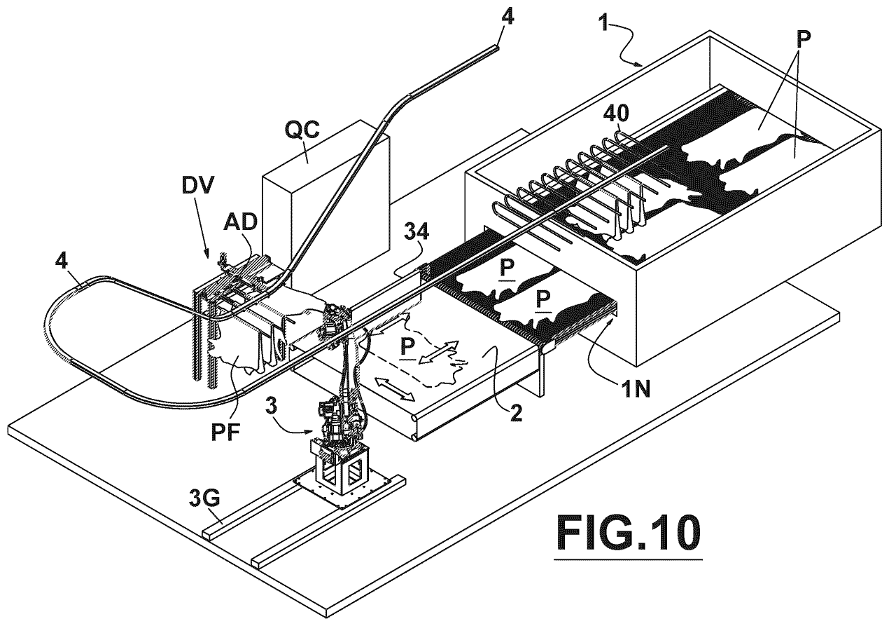

FIG. 10 represents a perspective view of the system of FIG. 5;

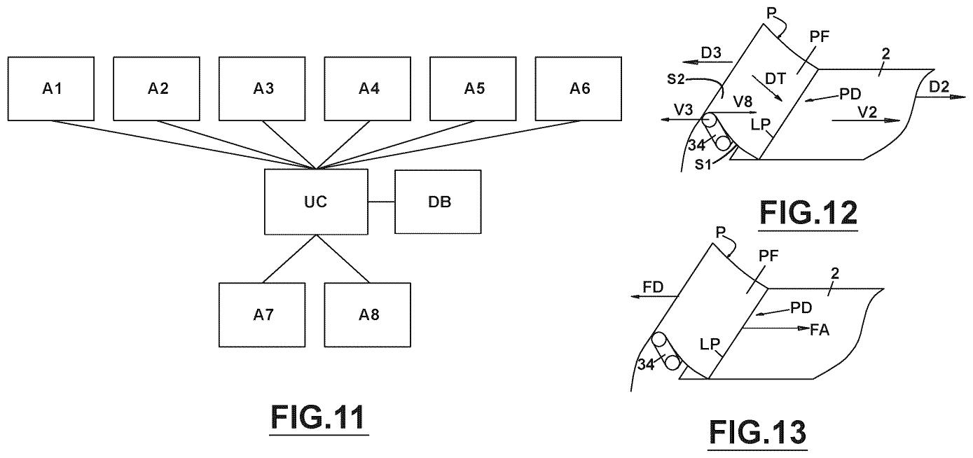

FIG. 11 is a simplified block diagram relating to a possible control system that can be implemented in a device according to the present invention;

FIG. 12 schematically represents a step of deposition of a hide on a deposition support;

FIG. 13 is a diagram similar to that of FIG. 12, in which the forces acting on a hide during deposition are represented;

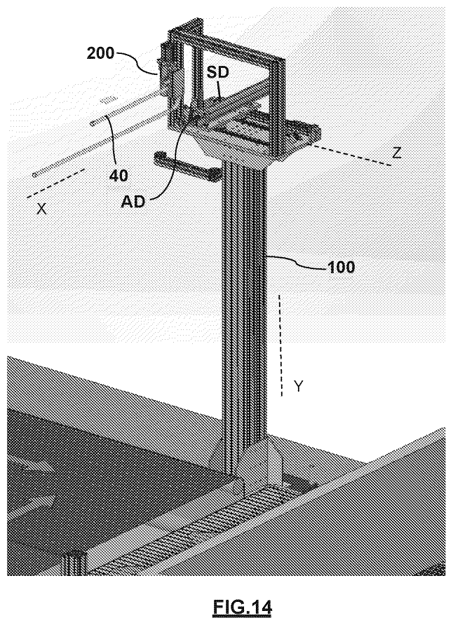

FIG. 14 is an image showing only one hanger of an overhead conveyor (not shown in this figure) and a spreading device according to a further aspect of the present invention;

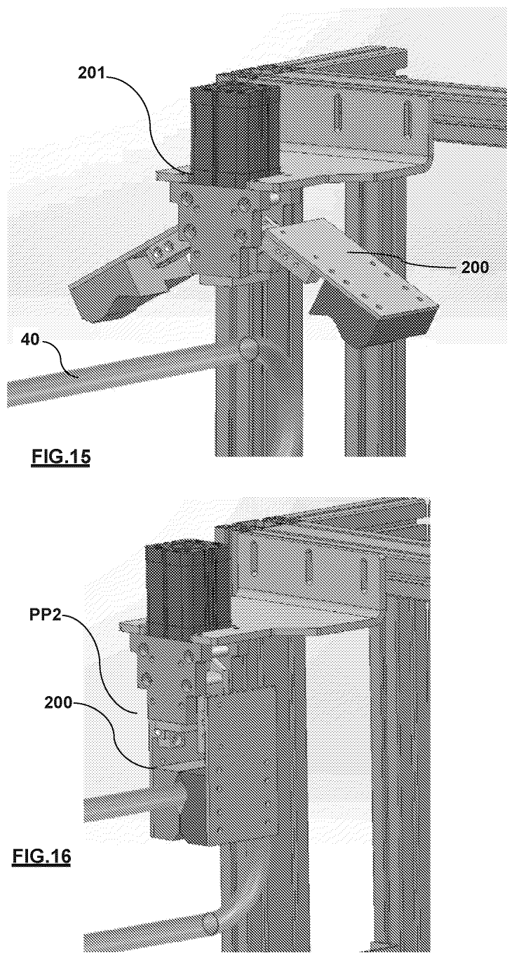

FIG. 15 and FIG. 16 show in sequence the operation of the gripping means of the aforementioned hanger;

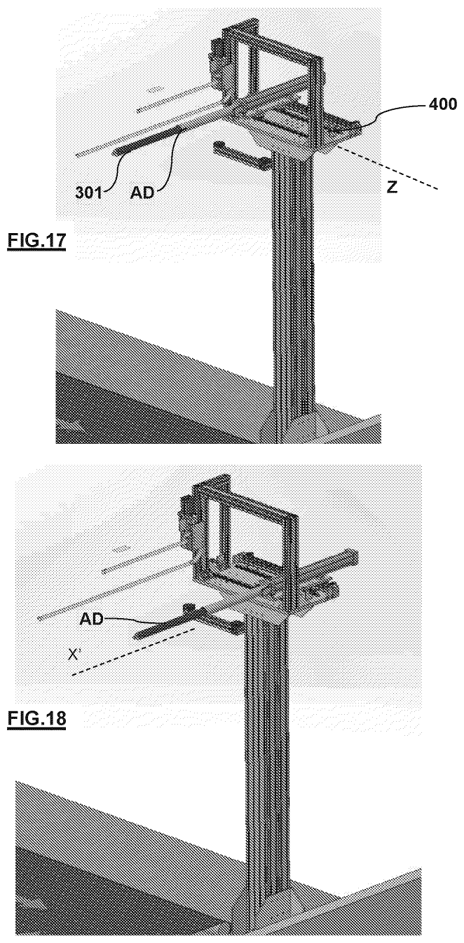

FIG. 17 and FIG. 18 show in sequence the extraction of a spreader cylinder and a spreader movement of said cylinder;

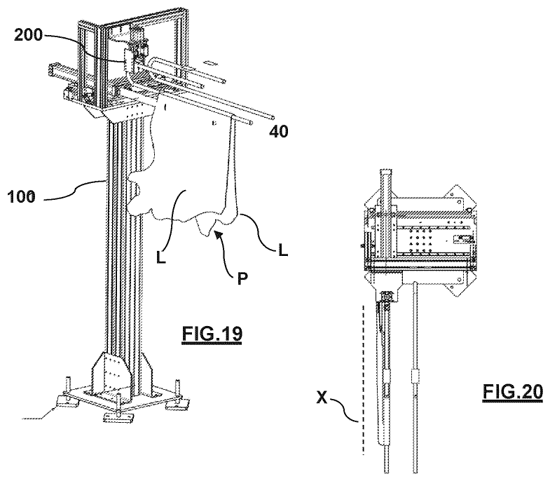

FIG. 19 is a view of the device according to the invention with a sheet made of a flexible material, such as for example a hide hanging from the hanger, in which the device has the spreading means in the closed position;

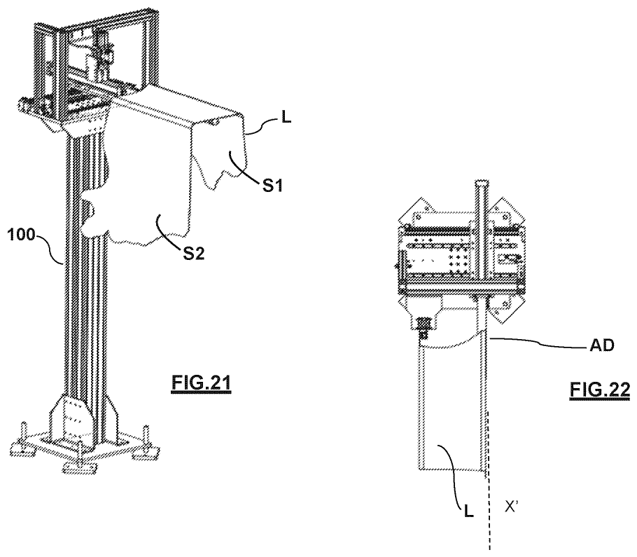

FIG. 20 is a top view of the aforementioned device with the spreading means in the closed position of FIG. 19;

FIG. 21 is a view of the device with the hide in a suitable position for easy engagement thanks to the spacing action of the two opposing hide flaps by the spreader;

FIG. 22 is a top view of the device shown in FIG. 21;

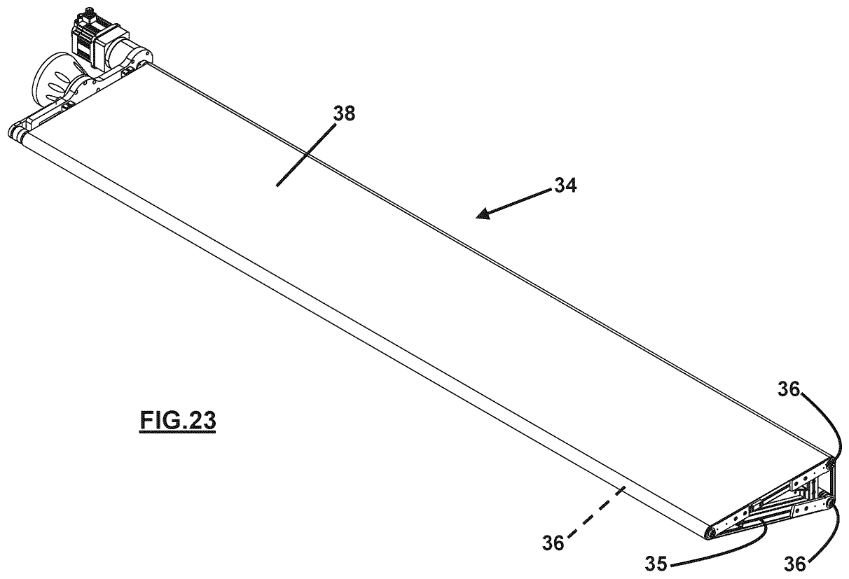

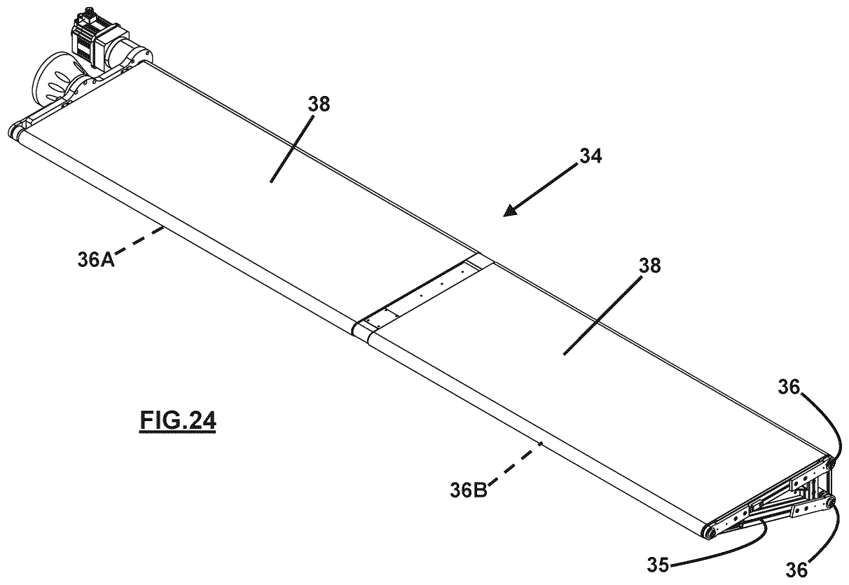

FIGS. 23 and 24 exemplificatory show two further embodiments of the tool (34).

For example, a method and a device according to the present invention can be used for handling animal hides intended to be positioned in a predefined position before being introduced into a chemical, mechanical or chemical-mechanical treatment unit in a tanning plant.

Said method and device are particularly, even if not exclusively, suitable for handling quality or even valuable animal hides, given their ability to leave no mark on their surfaces.

Moreover, said method and said device, as will be clearer from the following description, according to an aspect of the invention allow the pickup member never to come into contact with one of the two surfaces of the flexible material, thus completely protecting it from the effects of the picking, handling, release and deposition operations.

This contributes to preserving the quality of the flexible material, in particular, although not exclusively, when the flexible material has two surfaces with different characteristics as generally occurs in the case of animal hides.

In this case this avoids, in particular, that the picking device comes into contact with the so-called “grain side” of the hide, i.e. the most valuable surface of the hide, the quality of which must always be preserved during all industrial handling operations.

The following description provides examples relating to the method of the present invention and the construction and use of a device in accordance with the present invention.

For example, the flexible materials can be hides (P) intended to be introduced in a stretched condition into a finishing unit such as for example a spraying tunnel in which products having a given chemical composition are sprayed onto the hides.

The process that supplies the hides destined for the finishing unit is a known process which, therefore, will not be described in greater detail.

In the attached drawings, the finishing unit is schematically indicated by the block (1) and consists of a spray tunnel set up in a finishing area (R) for the hides.

The finishing area (R) can be an area of the same plant in which the tanning of the hides is carried out or it can be an area set up at a different site.

Typically, the finishing area (R) is arranged downstream of other areas or zones where preparation operations are carried out for the tanning of incoming hides (PC), tanning (C), mechanical processing of wet hides (LU), re-tanning, dyeing and greasing (RT) and drying (AS). In these areas (PC, C, LU, RT, AS) corresponding equipment known per se are installed. The hides (P) are introduced into the finishing unit (1) by means of a transport unit (2) on which the same hides (P) are positioned with one of the two surfaces (S1, S2) of said hides (P) completely in contact with the transport unit (2). For example, the transport unit (2) is a conveyor belt configured for transporting the hides (P) along a predefined direction (D2) up to an infeed section (1N) of the finishing unit (1).

In this example, a handling device according to the present invention is enslaved to the transport unit (2) and is configured for picking up the hides (P) from a corresponding support in a predefined picking area (PP) and depositing them on the transport unit (2). In the example, the hides handling device comprises an anthropomorphic industrial robot (3) with six degrees of freedom arranged and acting in a maneuvering space (S3) which intercepts both one side of the transport unit (2) and the support from which the hides (P) are taken. The maneuvering space (S3) is a space in which the industrial robot (3) can freely move while picking up the hides (P) and placing them on the transport unit (2).

In this example, the industrial robot (3) is of the type known per se from a structural and functional point of view, comprising a supporting structure (30) arranged in a predetermined area of the aforesaid maneuvering space (S3), and an arm having two elements (31, 32), articulated on the supporting structure (30) by means of a respective rear element (32). Said arm is controlled by respective actuators to be able to rotate on the supporting structure (30) about a vertical axis (J1). Furthermore, the rear element (32) can rotate around a first horizontal axis (J2), while the front element (31) of the same arm can rotate on the rear element (32) around a further horizontal axis (J3). The front element (31) of said arm is equipped with a wrist (33) carried by a fork (330) mounted on the distal part of the same front element (31). The fork (330) is controlled by a corresponding actuator which controls its rotation around a further axis (J4), i.e. around a longitudinal axis of said second element (31). The wrist (33) is mounted on the fork (330) with an actuator which controls its rotation around a fifth axis (J5). The fifth axis (J5) is an axis orthogonal to the two legs of the fork (330). The end part of the wrist (33) is defined by a flange (331) which, in turn, rotates around a sixth axis (J6), the latter being oriented orthogonally to said flange. The rotations around said axes (J1, J2, J3, J4, J5, J6) are controlled by respective actuators (A1, A2, A3, A4, A5, A6) represented in the block diagram of FIG. 11 where the reference “UC” denotes a programmable control system whose architecture is per se known to the industrial automation technicians.

Preferably, the supporting structure (30) is mounted on a guide (3G) which allows the industrial robot (3) to be arranged in a position more or less close to the transport unit (2). For example, in FIG. 9 the robot (3) is distanced from the transport unit (2) to allow an operator (OP) to access this unit by having the necessary space to move freely. Conversely, in FIG. 8 the robot (3) is in a position close to the transport unit (2). For example, the guide (3G) is a rectilinear guide oriented along the aforementioned direction “D2” and arranged upstream of the transport unit (2).

In the drawings, the reference “QC” denotes a control panel set up in an area outside the maneuvering space (S3) of the industrial robot (3).

For example, a Kawasaki industrial robot model BX100L or model BX130X may be used.

Again, for example, a Fanuc R-1000 series industrial robot can be used.

In accordance with the present invention, the industrial robot (3) is provided with a tool (34) configured for picking up the individual hides (P) at the picking point (PP) and placing them on the transport unit (2). Said tool (34) is mounted on the wrist (33) by means of the flange (331), so that it is possible to move the tool (34) in the maneuvering space (S3) by controlling the movement of the arm (31, 32), and the rotation of the flange (331) on which the tool (34) is mounted.

For example, the tool (34) comprises a frame (35) on which two rollers (36) oriented parallel to the axis (J6) are mounted. A corresponding actuator (37) is connected to one of said rollers (36) and controls the rotation thereof around the respective longitudinal axis. The actuator (37) is mounted on one side of the frame (35). On the same side, the frame (35) is centrally engaged on the flange (331). A web (38) is mounted on the rollers (36) closed in a loop on the rollers themselves which, therefore, guide their movement along the direction (DT) orthogonal to the axis (6).

Said web (38) can be a single continuous web-shaped element or it can be composed of a plurality of elements as further disclosed in the following.

In practice, the rotation of the flange (331) determines the corresponding rotation of the frame (35) around the axis (J6) and the actuator (37) controls the movement (DT) of the web (38) with respect to the frame (35). The coordinated movements of the arm (31, 32) with respect to the supporting structure (30), of the wrist (33) with respect to the arm (31, 32) and of the frame (35) with respect to the wrist (33) allow to control the movement of the tool (34), and with it the movement of the web (38), within the maneuvering space (S3). In particular, the frame (35) is moved between the point (PP) for picking up the hides and a point (PD) for placing them on the transport unit (2). In general, the spatial orientation of the frame (35) at the hide pick-up point and at the hide deposition point will be different from each other. With reference to the example shown in FIGS. 5-10, the hides (P) are conveyed to the collection point (PP) by means of an overhead conveyor (4) equipped with hangers (40) onto which the hides (P) are hung, typically assuming an inverted “U” configuration with the grain side (PF) out. Such a configuration is also shown in FIGS. 14-22.

At the picking point (PP) a spreader (DV) can provided, configured to determine the spreading of one side of the hides (P) that reach the picking point (PP). The spreader (DV) can be used to form, between the two surfaces of the hides hung on the hangers, a space sufficient to insert the tool (34) mounted on the industrial robot (3).

For example, the spreader (DV) consists of a rod (AD) mounted longitudinally sliding on a respective support (SD) that, in turn, is mounted sliding on a guide (GD) oriented orthogonally to the rod (AD). Therefore, the rod (AD) can be moved both longitudinally and parallel to itself. Reference being made to FIG. 14, said guide is mounted on a post (100) that is orthogonal to the hanger (40) and defines a corresponding axis (Y). The movement of the rod (AD) for operating the spreading of the hides is shown, in sequence, in FIGS. 17 and 18. FIGS. 8 and 9 also show two different positions of the rod (AD).

The block diagram of FIG. 11 shows an actuator (A7) that controls the longitudinal movement of the rod (AD) on the support (SD) and an actuator (A8) that controls the movement of the support (SD) on the guide (GD).

Furthermore, the post (100) of the spreader (DV) supports, on a respective top side, the rod (AD) and blocking means (200) comprising a blocking clap actuated by a control system so as to clamp the hanger in order to determine and ensure a predetermined position (PP2). In said predetermined position (PP2), the clamp engages the hanger whose oscillation is thus prevented. Said clamp is preferably, even if not exclusively, actuated by pneumatic actuation means. FIGS. 15 and 16 show the sequential movement of the blocking means (200), particularly in the case they are formed by a clamp, on the hanger (40).

When a hide (P) reaches the picking point (PP), the rod (AD) is retracted, as for example shown in FIG. 7 and in FIGS. 19 and 20, so as not to interfere with the transit of the hide. When the hide (P) reaches the sampling point (PP), the rod (AD) is extracted, inserting itself between the counter-facing internal sides of the hide suspended to the hanger, and is translated in the extracted position along the guide (GD) parallel to the direction (D2) for example as shown in FIG. 8 and in FIGS. 21 and 22. This determines the divarication of one side of the hide (P) with respect to the other side of the same hide, so that a space is formed in which the tool (34) is inserted. Preferably, the rod (AD) is formed by a telescopic piston.

Depending on the diameter of the rods that form the hangers, the spreader may not be necessary. In particular, for example, if the diameter of these rods is less than 25 mm, it could be preferable to use the spreader since in this case the space between the counter-facing sides of the hides hung on the hangers could be insufficient for inserting the tool (34). Conversely, if the diameter of the rods that form the hangers is of such a value as to keep the counter-facing sides of the hides hanging from them sufficiently spaced, for example if the diameter of these rods is greater than 25 mm, then the spreader may not be necessary.

At the pick-up point (PP) the frame (35) is oriented vertically, i.e. with a free side (350) (side opposite to the side where is mounted the actuator 37 which controls the movement of the web (38) oriented orthogonally to the hanger (40) present in the pick-up point (PP). In this configuration, the frame (35) is lifted, disengaging the hide (P) from the hanger (40). In this way, the hide (P) is transferred onto the tool (34), since it has two flaps, a front and a rear flap, protruding downwardly from the frame (35). In this phase, the web (38) is stopped.

Subsequently, the tool (34) is led by the robot (3) towards the hide deposition point (PD), where the frame (35) is rotated around the axis (J6) in such a way that a front edge of the hide (P) is deposited on the transport unit (2). At the same time, the actuator (37) moves the web (38) in the same direction as the direction (D2) of the transport unit (2) and the robot (3) lowers the tool (34) towards the transport unit (2) and moves the tool itself, with a pre-established speed, along a direction opposite to the direction (D2) of the transport unit (2). The vectorial sum of the speed (V8) of the web (38) and the backward speed (V3) of the of the tool with respect to the transport unit (2) is lower than the forward speed (V2) of the latter in direction (D). In the diagram of FIG. 12, “V3” represents the backward speed of the tool (34) parallel to the transport unit (2) during the hide deposition on the latter, “V8” represents the speed of web (38) and “V2” represents the forward speed of the transport unit (2) along the direction (D2). In absolute values it is: V8−V3<V2. Preferably, it is: V8−V3˜V2, i.e. the difference V8−V3 is of the same order of magnitude as the value of V2.

In practice, with reference to the diagram of FIG. 12, while a part (LP) of the hide (P) is being deposited on the transport unit (2), another part of the same hide is engaged by the tool (34) which is simultaneously moved in the direction opposite to the direction of movement of the transport unit (2), i.e. in the direction opposite to the direction along which the hide is released by the tool (34).

Subsequently, once the transfer of the hide (P) from the tool (34) to the transport unit (2) is completed, the tool (34) is brought back to the hides picking point (PP) to repeat the cycle previously described.

Therefore, the tool (34) is configured to engage the hide (P) at the pickup point (PP) and to deposit the same hide (P) on the transport unit (2) and is also configured to lay out the hide (P) while placing the latter on the transport unit (2).

By adjusting the speeds V3 and V8 as indicated above with respect to the speed V2, the hide is subjected to a distension force, i.e. a traction force, while it is being transferred onto the transport unit (2).

The speeds V3 and V8 can be adjusted, with respect to the speed V2, to achieve a more or less quick deposition of the hide on the transport unit (2): with the same backward speed (V3) of the tool (34) and the same forward speed (V2) of the transport unit (2), by increasing the unwinding speed (V8) of the web (38) there is an increase in the deposition speed of the hide on the transport unit (2), i.e. the total time required for the complete transfer of the hide from the tool (34) to the transport unit is reduced. By keeping the tool (34) in a fixed position (V3=0) it will be possible to achieve a slower deposition of the hide on the transport unit. If the advancement speed (V2) of the transport unit (2) is kept at a constant value, by adjusting the speeds V8 and V3 it will be possible to consequently adjust the deposition speed of the hide on the transport unit (2).

In practice, the tool (34) described above is a tool having a movable hide (P) engagement surface, the speed of which can be adjusted to correspondingly adjust the hide deposition speed on the transport unit. By adjusting the speed of this mobile surface, the tension to which the hider is subjected during the deposition on the transport unit is also adjusted. The tension adjustment range to which the hide is subjected during the deposition on the transport unit can be further extended by adjusting the backward speed (V3) of the tool.

The aforesaid mobile surface of the tool (34) is at the same time a surface for holding the leather (P) and for releasing it at a controlled speed. In other words, the tool (34) releases the hide (P) by making it to translate, during the release, with a pre-established release speed while the same hide is deposited on the transport unit (2). Therefore, during the hide deposition phase, the hide is simultaneously released by the tool (34). In the example described above, the hide release speed determined by the tool (34) is the speed “V8”.

Preferably, in order to facilitate the tensioning of the hide during the deposition phase of the same on the transport unit (2), the material of which the web (38) is made and, more generally, the material of which is made the mobile surface engaging the hide, has a higher coefficient of friction than the material of which the transport unit (2) is made with respect to the hide (P).

The applicants have conducted experimental tests during which they have verified that by using materials which satisfy the aforesaid condition, a deposition of the hides on the transport unit (2) is obtained without the formation of folds or wrinkles of such dimensions as to compromise a correct execution of the subsequent hide processing operations.

The following tables show data relating to the tests performed.

In particular, the applicants conducted the tests using various types of leather and measuring with a dynamometer, at different speeds of the deposition unit, consisting of a wire conveyor belt of the type commonly used for handling animal hides in tanning processes, the value of the friction force developed between the hides and said transport unit and then calculating the value of the respective coefficient of friction; the data obtained and the experimental conditions adopted are reported in the following table 1.

The following table 2 shows instead the experimental data obtained in carrying out similar experimental tests, in which the friction force which develops between the hides and the aforesaid web (38) was measured.

In said tables the symbols indicated therein have the following meaning:
A1: printed leather with outer side in contact with the transport unit;
B1: suede with outer side in contact with the transport unit;
C1: rigid split leather with the outer side in contact with the transport unit;
D1: standard half calf split leather with the outer side in contact with the transport unit;
E1: half calf leather with the outer side in contact with the transport unit;
A2: printed leather with inner side in contact with the transport unit;
B2: suede with inner side in contact with the transport unit;
C2: rigid split leather with the inner side in contact with the transport unit;
D2: standard half calf split leather with the inner side in contact with the transport unit;
E2: half calf leather with the inner side in contact with the transport unit;
VA2: advancement speed of the transport unit in the hides deposition phase;
FA2: friction force developed by the contact between the hides and the transport unit;
CA2: coefficient of dynamic friction due to the contact between the hides and the transport unit;
VA8: release speed of the hides from the surface of the tool (34);
FA8: friction force developed by the contact between the hides and the surface of the tool (34);
CA8: coefficient of dynamic friction due to contact between the hides and the surface tool 34.

TABLE 1

| A1 | VA2 [m/min] | FA2 [g] | CA2 |
|---|---|---|---|
| | 6.7 | 220 | 0.32 |
| | 10.6 | 240 | 0.35 |
| | 15 | 240 | 0.36 |
| A2 | VA2 [m/min] | FA2 [g] | CA2 |
| | 6.7 | 300 | 0.43 |
| | 10.6 | 335 | 0.48 |
| | 15 | 335 | 0.48 |
| B1 | VA2 [m/min] | FA2 [g] | CA2 |
| | 6.7 | 520 | 0.70 |
| | 10.6 | 600 | 0.81 |
| | 15 | 630 | 0.85 |
| B2 | VA2 [m/min] | FA2 [g] | CA2 |
| | 6.7 | 550 | 0.74 |
| | 10.6 | 570 | 0.77 |
| | 15 | 570 | 0.77 |
| C1 | VA2 [m/min] | FA2 [g] | CA2 |
| | 6.7 | 430 | 0.38 |
| | 10.6 | 455 | 0.40 |
| | 15 | 485 | 0.43 |
| C2 | VA2 [m/min] | FA2 [g] | CA2 |
| | 6.7 | 890 | 0.78 |
| | 10.6 | 880 | 0.77 |
| | 15 | 900 | 0.79 |
| D1 | VA2 [m/min] | FA2 [g] | CA2 |
| | 6.7 | 170 | 0.16 |
| | 10.6 | 210 | 0.20 |
| | 15 | 220 | 0.21 |
| D2 | VA2 [m/min] | FA2 [g] | CA2 |
| | 6.7 | 680 | 0.64 |
| | 10.6 | 735 | 0.70 |
| | 15 | 735 | 0.70 |
| E1 | VA2 [m/min] | FA2 [g] | CA2 |
| | 6.7 | 285 | 0.35 |
| | 10.6 | 305 | 0.38 |
| | 15 | 305 | 0.38 |
| E2 | VA2 [m/min] | FA2 [g] | CA2 |
| | 6.7 | 655 | 0.81 |
| | 10.6 | 675 | 0.83 |
| | 15 | 675 | 0.83 |

TABLE 2

| A1 | VA8 [m/min] | FA8 [g] | CA8 |
|---|---|---|---|
| | 6.4 | 1500 | 2.16 |
| | 9.6 | 1700 | 2.45 |
| | 14.4 | 1900 | 2.73 |
| A2 | VA8 [m/min] | FA8 [g] | CA8 |
| | 6.4 | 890 | 1.28 |
| | 9.6 | 940 | 1.35 |
| | 14.4 | 950 | 1.37 |
| B1 | VA8 [m/min] | FA8 [g] | CA8 |
| | 6.4 | 1900 | 2.55 |
| | 9.6 | 2000 | 2.68 |
| | 14.4 | 1900 | 2.55 |
| B2 | VA8 [m/min] | FA8 [g] | CA8 |
| | 6.4 | 2000 | 2.68 |
| | 9.6 | 2000 | 2.68 |
| | 14.4 | 1900 | 2.55 |
| C1 | VA8 [m/min] | FA8 [g] | CA8 |
| | 6.4 | 1700 | 1.49 |
| | 9.6 | 1500 | 1.32 |
| | 14.4 | 1700 | 1.49 |
| C2 | VA8 [m/min] | FA8 [g] | CA8 |
| | 6.4 | 2700 | 2.37 |
| | 9.6 | 2500 | 2.19 |
| | 14.4 | 2300 | 2.02 |
| D1 | Speed [m/min] | FA8 [g] | CA8 |
| | 6.4 | 5000 | 4.74 |
| | 9.6 | 6000 | 5.69 |
| | 14.4 | 5000 | 4.74 |
| D2 | VA8 [m/min] | FA8 [g] | CA8 |
| | 6.4 | 1500 | 1.42 |
| | 9.6 | 1600 | 1.52 |
| | 14.4 | 1800 | 1.71 |
| E1 | VA8 [m/min] | FA8 [g] | CA8 |
| | 6.4 | 1700 | 2.10 |
| | 9.6 | 1800 | 2.22 |
| | 14.4 | 2000 | 2.47 |
| E2 | VA8 [m/min] | FA8 [g] | CA8 |
| | 6.4 | 1800 | 2.22 |
| | 9.6 | 1900 | 2.35 |
| | 14.4 | 2000 | 2.47 |

The device and the process according to the invention allow in all the tested conditions to obtain an effective control of the deposition of the hides, which appears extended and without wrinkles on the deposition unit, for all the web speeds tested and for any type of hide used.

Furthermore, the data generated in the various operating conditions make up an impressive database (DB) which, for example, makes it possible to automatically determine the values of the forces developed in correspondence with the various surfaces involved, according to the characteristics of the surfaces themselves and of the speed of the transport unit (2) in the processing line, thus making it possible to optimize the phase of transporting the materials from one point of the line to another.

The experimental tests were carried out on dry hides. However, the hides (P) can be damp hides intended to be introduced into a drying tunnel (not visible in the drawings) before being subjected to further processing. The structure and operation of the industrial robot (3) and the tool (34) are identical to those already described in relation to the previous example. In this case, the transport unit (2) is associated with the drying tunnel and is intended to introduce the hides into an infeed section of the same tunnel. The system as a whole is identical to the one described in the previous example, except in that the hides treatment unit is a drying tunnel rather than a spray tunnel. Also in this case the hides (P) are placed on the transport unit (2) in a stretched position to reach the downstream treatment unit, in particular in this example the drying tunnel, without presenting appreciable folds or wrinkles.

In a further method of use, the industrial robot (3) can deposit the hides (P) on a fixed plane, which replaces the previously described transport unit (2) or, depending on the operations to be performed on the hides (for example, a visual inspection of the hides by qualified personnel before placing them in a treatment unit such as a spraying tunnel or a drying tunnel), the transport unit (2) is stopped in the hides deposition phase. In this case, the speed (V2) of the surface on which the hide is deposited is zero and the retraction with non-zero speed (V3) of the tool (34) during the hide placement on the fixed plane determines the required distension.

The use of an industrial robot (3) makes it possible to effectively manage the movements of the picking device (34) in the space (S3) and ensures high flexibility in positioning the hides on the deposition surface (2). For example, the hides (P) can be deposited on the surface (2) oriented longitudinally or transversally with respect to the same surface.

In FIG. 8 and FIG. 9 a hide (P) drawn with a dotted line is arranged on the surface (2) with an orthogonal orientation with respect to the orientation of the hides previously placed on the same surface.

Furthermore, the use of an industrial robot (3) allows to modify more easily, by program, the deposition point (PD) of the hides on the deposition surface (2), and also allows to modify said point (PD) more easily depending on the length or width of the hides (P).

In the examples described above, a process is implemented comprising:
a step of picking up a flexible material (P) from a pick-up point (PP) by means of a picking member configured to engage a first portion of the flexible material (P) in correspondence with an engagement surface provided by the picking member,
a step of moving the picking member along a predefined trajectory until a second free portion (LP) of the flexible material (P) is placed on a surface (2) for depositing the hides at a deposit point (PD) of said surface, wherein
during the deposition phase of each flexible material (P) a friction force develops between the hide (P) and the deposition surface (2) of the flexible materials, and
the second portion of the flexible material (P) is suspended from the picking member and, after the deposition of said free portion of the flexible material at the deposition point (PD), the picking member exerts on the flexible material (P) a distensive force (FD) having a lower magnitude than said friction force (FA) while the flexible material (P) is positioned on said surface (2) and is released by the picking member with a controlled release speed, the distensive force (FD) being a force oriented in a direction to opposite said friction force (FA), such that the flexible material (P) is tensioned during its positioning on the deposition surface (2) while it is released with controlled speed by the picking member, and said picking member comes into contact, during the entire handling operation, with only one (S1) of the two surfaces (S1, S2) of the flexible material (P).

In the examples described above, a process is also carried out comprising:
a step of picking up a flexible material (P) from a pick-up point (PP) by means of a picking member (34) configured to engage a first portion of the flexible material (P) in correspondence with a contact area of the flexible material with an engagement surface provided by the picking member,
a step of moving the picking member along a predefined trajectory until a second free portion (LP) of the flexible material (P) is placed on a surface (2) for depositing the hides at a deposit point (PD) of said surface, wherein
during the deposition phase of each flexible material (P) a friction force develops between the hide (P) and the deposition surface (2) of the flexible materials, and
the second portion of the flexible material (P) is suspended from the picking member and, after the deposition of said free portion of the flexible material at the deposition point (PD), the picking member exerts on the flexible material (P) a distensive force (FD) having a lower magnitude than said friction force (FA) while the flexible material (P) is positioned on said surface (2) and is released by the picking member with a controlled release speed, the distensive force (FD) being a force oriented in a direction to opposite said friction force (FA), such that the flexible material (P) is tensioned during its positioning on the deposition surface (2) while it is released with controlled speed by the picking member, and said contact area varies during the releasing and the deposition of the flexible material on said surface (2).

From the foregoing description it is evident that a process according to the present invention can comprise, in particular, one or more of the following further characteristics, even combined with each other:
the pick-up member engages the flexible material (P) through an engagement surface thereof having a coefficient of friction greater than the coefficient of friction presented by the deposition surface (2) with respect to the flexible material (P).
said engagement surface is a surface by which the release speed of the flexible material (P) by means of the pick-up member is controlled, said surface being moved with a pre-established speed along a pre-established release direction during the positioning of the flexible material on the deposition surface (2).
said engagement surface is subjected to rotation with a predetermined angular speed around a respective axis of rotation (J6).
said engagement surface is a movable surface (38) which controls the release speed of the flexible material.
said engagement surface is formed on a pick-up member mounted on an industrial robot (3).
the deposition surface (2) is a mobile surface or a fixed surface.
during the deposition of the flexible material, the picking up device is moved with predefined speed (V3) along a direction (D3) opposite to a release direction (DT) of the hide by the picking up device;
said engagement surface is a flat surface subject to translation in said release phase.

From the foregoing description it is also evident that a device according to the present invention is a device comprising pick-up means configured to engage a flexible material (P) in correspondence with an area of contact of the flexible material with said pick-up means and movement means for said picking means programmed to move the picking means along a predefined trajectory to arrange a second free portion of the flexible material (P) on a given deposition point (PD) of a given target surface (2) with the development of a friction force (FA) between the flexible material (P) and said surface (2), characterized in that said picking means are controlled by a control device programmed such that the same picking means exert on the material flexible (P) a distensive force (FD) of lower magnitude than said friction force (FA) while the flexible material (P) is released by the picking means with a controlled release speed and at the same time is positioned on said surface (2), the distensive force (FD) being a force oriented in a direction opposite to the friction force (FA), and the control device controls the movement of the flexible material (P) with respect to the pick-up member while the same flexible material (P) is released and positioned on said surface (2) varying said contact area during the release and the deposition of the flexible material on said surface (2).

The above description also shows that a device according to the present invention can be configured as a device for the automated handling of flexible laminar materials, comprising pickup means configured to engage a flexible material (P) at a first portion of the latter and handling means of said picking means programmed to move the picking means along a predefined trajectory to arrange a second free portion of the flexible material (P) on a given deposition point (PD) of a given target surface (2) with the development of a friction force (FA) between the flexible material (P) and said surface (2), characterized by the fact that said withdrawal means are controlled by a control device programmed such that the picking means come into contact with only one surface (S1) of the flexible material (P) and exert on the flexible material (P) a distension force (FD) of a lower magnitude than said friction force (FA) while the flexible material (P) is released by the picking means with a controlled release speed and at the same time is positioned on said surface (2), the distension force (FD) being a force oriented along a direction opposite to the friction force (FA), and the control device controls the movement of the first portion of the flexible material (P) with respect to the pick-up member while the same flexible material (P) is released and positioned on said surface (2).

A device in accordance with the present invention may also have, in particular, one or more of the following characteristics, even combined with each other:
the pick-up member is provided with an engagement surface having a coefficient of friction greater than the coefficient of friction presented by the deposition surface (2) with respect to the flexible material (P).
said engagement surface is a movable surface by which the release speed of the flexible material (P) by the pickup member is controlled, said movable surface being moved with a predetermined speed along a predetermined release direction (DT) while placing the flexible material on the deposition surface (2).
said engagement surface is formed on a pick-up member mounted on an industrial robot (3).
the control device controls the movement of the first portion of the flexible material (P) through said engagement surface.
said engagement surface is a flat surface subject to translation in said release phase.
the deposition surface (2) is a mobile surface or a fixed surface.
during the deposition of the flexible material, the pick-up device is moved with a predefined speed (V3) along a direction (D3) opposite to a release direction (DT) of the flexible material by the pick-up device.
the device comprises means (DV) configured to arrange the flexible materials in a pick-up position, said means (DV) being arranged and acting at a predetermined point (PP) for picking up the flexible materials and being provided with a spreading element (AD) controlled to spread one side of the flexible materials during the preparation of the same for their removal.

Advantageously, the pick-up member can be controlled by a control unit (UC) programmed to control the magnitude of the distension force (FD) as a function of the friction coefficient of the engagement surface of the pick-up member and the friction coefficient of the deposition surface (2) with respect to the flexible material (P). For this purpose, a database (DB) can be set up in which a plurality of values of said friction coefficients are stored and the control unit (UC) can have access to the database (DB) so that an operator can select time by time an operating parameter of the system (for example, the aforesaid speeds V3 and V8) on the basis of the flexible materials being processed and the materials of which the deposition surface and the engagement surface of the pickup member are made.

In a possible practical embodiment of a device in accordance with the present invention, the pick-up member comprises a frame (35) on which at least two rollers (36) are mounted parallel to each other and controlled by a corresponding actuator (37) which controls their rotation around the respective longitudinal axes, and a web (38) is mounted on the rollers (36) closed in a ring on the rollers themselves which, therefore, guide their movement in the direction (DT) orthogonal to a central longitudinal axis of the frame (35) which is engaged on a terminal axis (6) of a robotic arm (3).

It is understood that the number of the aforesaid rollers (36) can vary according to different variables and operating conditions, such as in particular the width and number of elements which form the web (38), the width of the frame (35), the dimensions of the flexible material (P) to be handled, or in function of the width of the space within which the picking member must be inserted to allow the engagement of the flexible material (P).

By way of example, the rollers (36) can be two in number, as shown in the embodiment of FIG. 6. In this example, the web (38) is formed by a single continuous web-like element.

Still by way of example, the rollers (36) can be three in number, with the respective longitudinal axes positioned according to a triangular arrangement. Such a configuration is represented by way of example in FIG. 23 in which the wedge-shaped profile of the frame (35) can also be appreciated.

In a particularly preferred embodiment of the invention, such as for example the one represented in FIG. 24, in the realization of the tool (34), two rollers (36) have a length corresponding to the width of the frame (35) and a third roller (in front position in the drawing) is divided into two elements (36A, 36B) axially aligned with each other, the sum of the lengths of which equals the length of each of the other two rollers (36). This solution is particularly preferred for strengthening the structure of the frame (35) and consequently of the tool (34), with respect to flexural stresses, when the tool has to handle hides of large dimensions and therefore considerable weight (such as, for example, those handled with conveyor webs 3400 mm wide).

In this embodiment preferably the two rollers (36) have a length of 3400 mm and the rollers (36A, 36B) are both 1700 mm long.

The length of the rollers (36) is typically in the range from 1000 to 4000 mm.

The length of the assembly constituted by the rollers (36A, 36B) is typically included in the range from 1000 to 4000 mm.

The length of the rollers (36A, 36B) is typically in the range from 500 to 2000 mm; preferably the two rollers (36A, 36B) have the same length.

In a further preferred embodiment of the invention, and again with the aim of obtaining greater flexural strength of the structure, it is also possible to envisage the use of more than one webs (38), preferably two webs arranged side-by-side, as shown in FIG. 24.

This solution, like the previous one, has the purpose of making the structure of the frame (35) and that of the picking member in general more robust and resistant in the case of handling flexible materials, such as hides, of large dimensions, and therefore of high weight; therefore, it is particularly useful in plants with 3400 mm wide conveyor belts.

A particularly preferred configuration of the invention is therefore that which provides for the use of two rollers (36) on one side of the tool (34), two rollers (36A, 36B) axially aligned on another side of the tool (34), and two side-by-side webs (38) each of which is wound on the rollers (36) and on a respective roller (36A) or (36B).

Advantageously, the two rollers (36) each have a length of 3400 mm, the two rollers (36A, 36B) each measure 1700 mm in length and the two webs (38) each measure 1700 mm along the direction of the rollers (36, 36A, 36B).

Furthermore, in a still further preferred embodiment of the invention, it is possible to provide the presence, on the web, of a sensor for detecting the presence of the hide on the web and therefore capable of signaling any anomalies in the engagement by the picking member.

It is understood that what has been described with reference to animal hides can equally be applied to other flexible materials intrinsically characterized by low stiffness and therefore subject to the formation of folds or wrinkles when they are transferred from a picking point to a different deposition point. For example, these materials can be, in addition to animal hides, synthetic hides, sheets of non-woven fabric, sheets of plastic material and similar flexible laminar materials, in which the thickness is relatively small.

It is also understood that instead of the movable surface (38), a fixed surface may be provided which constitutes the external surface of the tool which engages the hide. By appropriately regulating the rotation speed of the tool (34) around the axis (J6) it is also possible to control the release speed of the hide from the tool (34).

With reference to FIGS. 14-22, a possible embodiment of a device is described below which facilitates the engagement of the hides (or flexible materials in the form of sheets) from the hangers of the overhead conveyor by the manipulation device previously described or, more generally, by differently structured or configured manipulation devices.

With reference to said figures, facilitation device means a device capable of lifting and partially extending an edge (L) of a sheet (P) of flexible material hanging from a hanger (40), so as to create a maneuver space which allows a pick-up means to easily insert between the flap which has remained vertical and the partially raised flap (L), so as to be able to pick up said sheet (P) of flexible material easily.

In more detail, the hanger (40) is part of an overhead conveyor (4).

The sheet (P) is hung on the hanger in an inverted U shape, defining two opposite edges (L).

The hanger defines a horizontal “X” axis, parallel to the ground.

The facilitation device comprises a post (100) which, at its top side, supports locking means (200) and spreading means (AD).

The post is arranged perpendicular to the hanger and defines a vertical “Y” axis.

The locking means (200) comprise a locking gripper activated by a control system for engaging the hanger, in order to determine and guarantee a predetermined position (PP2). The gripper therefore engages the hanger preventing the oscillatory movement thereof.

The gripper is preferably, but not exclusively, operated by a pneumatic actuator (201).

The control system (not shown) includes suitable sensors which stop the advancement of the hangers in correspondence with the desired working position (PP2).

Regarding the spreading means, these comprise a piston (AD) arranged according to its own axis (X′) parallel to that of the hanger. The position (PP2) corresponds to that in which the axis (X′) of the piston (AD) and the axis (X) of the hanger are aligned on the same plane. In a preferred embodiment, the piston (AD) is a telescopic piston.

In the desired working position (PP2) the piston (AD) is extracted and when extended it enters between the two flaps (L) of the sheet hanging from the hanger (40), in the space generated by the positioning of the same sheet on the hanger.

Furthermore, the piston (AD) is mounted on the post (100) in a sliding manner. The piston (AD) is therefore free to slide along an axis (Z) perpendicular to the axis (X) of the hanger and to the axis (Y) of the post. This sliding is obtained by means of a linear guide (400) actuated by an actuator (preferably but not exclusively pneumatically operated).

The piston (AD), once extracted and entered between the two flaps (L), translates along the aforesaid axis (Z) allowing to increase the distance between the flaps themselves and thus generate a useful space for picking up the sheet of flexible material by means of a picking device which allows the flexible material (P) to be unloaded from the hanger. By way of example, the flexible material pick-up device could be the pick-up member previously described with reference to FIGS. 1-13.

The flap (L) intercepted by the piston (AD) which translates in the direction of the axis (Z) is then partially raised, and for the raised part which is parallel to the X-Z plane, distended.

The piston (AD) can have at its end an insert (301) of a suitable shape to ensure minimum friction with the hide. This insert (301) can also have a reduced diameter with respect to the piston, to fit between the flaps of the sheet even if these were very close to each other.

The facilitation device according to the invention has numerous advantages.

In particular, the use of the pneumatic gripper, which allows to keep the hanger fixed in a fixed position, allows a high reliability of the system as it allows to always guarantee the insertion of the telescopic piston inside the space generated between the two flaps of the material (P) positioned on the hanger of overhead conveyor. Again, the spreading means allow the flaps of the sheet to be spread apart and to separate them efficiently and quickly. Once the flap has been suitably spread apart, it can be grasped or in any case engaged by a suitable manipulator.

It should be understood that the execution details can in any case vary in an equivalent way as regards the individual characteristics described and illustrated without thereby departing from the scope of the protection conferred by this patent in accordance with the appended claims.

1) Process for the automated handling of flexible laminar materials, comprising
a step of picking-up a flexible material (P) from a pick-up point (PP) by means of a pick-up member (34) configured to engage a first portion of the flexible material (P) in correspondence with a contact area of the flexible material with an engagement surface of the pick-up member,
a step of moving the pick-up member along a predefined trajectory until a second free portion (LP) of the flexible material (P) is placed on a deposition surface (2) for depositing the flexible materials at a deposition point (PD) on said surface, wherein
during the deposition step of each flexible material (P), a friction force develops between the flexible material (P) and the deposition surface (2) of the flexible materials,
characterized in that
the second portion of the flexible material (P) is suspended to the pick-up member, and, after the deposition of said free portion of the flexible material at the deposition point (PD), the pickup member exerts on the flexible material (P) a tension force (FD) of lesser intensity than said frictional force (FA) while the flexible material (P) is released on said surface (2) with a controlled release speed, the pick-up member being controlled by a control unit (UC) programmed to control the intensity of the tension force (FD) as a function of the friction coefficient between the engagement surface of the pick-up member and the flexible material (P) and the friction coefficient between the deposition surface (2) and the flexible material (P) and being a force oriented along a direction opposite to said frictional force (FA), such that the flexible material (P) is tensioned during its positioning on the deposition surface (2) while it is released with a controlled releasing speed by the pick-up member, wherein said pick-up member (34) is mounted on an industrial robot so that the engagement surface of the pick-up member (34) is movable and said contact area of the flexible material with the engagement surface varies during the release and the deposition of the flexible material onto said deposition surface (2).

2) Process for the automated handling of flexible laminar materials, comprising
a step of picking-up a flexible material (P) from a pick-up point (PP) by means of a pick-up member (34) configured to engage a first portion of the flexible material (P) in correspondence with an engagement surface of the pick-up member,
a step of moving the pick-up member along a predefined trajectory until a second free portion (LP) of the flexible material (P) is placed on a deposition surface (2) for depositing the flexible materials at a deposition point (PD) on said surface, wherein
during the deposition step of each flexible material (P), a friction force develops between the flexible material (P) and the deposition surface (2) of the flexible materials,
characterized in that
said pick-up member (34) is mounted on an industrial robot so that the engagement surface of the pick-up member (34) is movable,
the second portion of the flexible material (P) is suspended to the pick-up member, and, after the deposition of said free portion of the flexible material at the deposition point (PD), the pickup member exerts on the flexible material (P) a tension force (FD) of lesser intensity than said frictional force (FA) while the flexible material (P) is released on said surface (2) with a controlled release speed, the pick-up member being controlled by a control unit (UC) programmed to control the intensity of the tension force (FD) as a function of the friction coefficient between the engagement surface of the pick-up member and the flexible material (P) and being oriented along a direction opposite to said frictional force (FA), such that the flexible material (P) is tensioned during its positioning on the deposition surface (2) while it is released with a controlled releasing speed by the pick-up member,
said picking member comes into contact, during the entire handling operation, with only one (SI) of the two surfaces (SI, S2) of the flexible material (P).

3) Process according to claim 1 characterized in that the friction coefficient between the engagement surface of the pick-up member (34) and the flexible material (P) is higher than the friction coefficient between the deposition surface (2) and the flexible material (P).

4) Process according to claim 1 characterized in that said engagement surface is a surface by which the release speed of the flexible material (P) by the pick-up member is controlled, said surface being moved with predetermined speed along a predetermined release direction during the positioning of the flexible material on the deposition surface (2).

5) Process according to claim 1 characterized in that said engagement surface is subjected to rotation with a predetermined angular speed around a respective rotation axis (J6).

6) Process according to claim 1 characterized in that said engagement surface is a movable surface (38) which controls the speed of release of the flexible material.

7) (canceled)

8) Process according to one claim 1 characterized in that the deposition surface (2) is a mobile surface or a fixed surface.

9) Process according to claim 1 characterized in that during the deposition of the flexible material, the pick-up member is moved with a predefined speed (V3) along a direction (D3) opposite to a release direction (DT) of the flexible material by the pick-up member.

10) Device for the automated handling of flexible laminar materials, comprising pick-up means configured to engage a flexible material (P) in correspondence with a contact area of the flexible material with said pick-up means, and means for moving said pick-up means programmed for moving the pick-up means along a predefined trajectory for depositing a second free portion of the flexible material (P) on a predetermined deposition point (PD) of a predetermined target surface (2) with the development of a frictional force between the flexible material (P) and said surface (2), characterized in that said pick-up means are mounted on an industrial robot (3) so that the engagement surface of the pick-up means is movable and the pick-up means exert on the flexible material (P) a tension force (FD) of lesser magnitude than said frictional force (FA) while the flexible material (P) is positioned with a controlled release speed on said surface (2), the pick-up member being controlled by a control unit (UC) programmed to control the intensity of the tension force (FD) as a function of the friction coefficient between the engagement surface of the pick-up means and the flexible material (P) and the friction coefficient between the deposition surface (2) and the flexible material (P), and being oriented along a direction opposite to the friction force (FA), the control device controls the pick-up means while the same flexible material (P) is released and positioned onto said surface (2) varying the contact area during the release and the deposition of the flexible material onto said surface (2).

11) Device for the automated handling of flexible laminar materials, comprising pickup means configured to engage a flexible material (P) in correspondence with a first portion of the latter and handling means for said pick-up means programmed for moving the pick-up means along a predefined trajectory to arrange a second free portion of the flexible material (P) on a given deposition point (PD) of a given target surface (2) with the development of a friction force (FA) between the flexible material (P) and said surface (2), characterized by the fact that said pick-up means are mounted on an industrial robot (3) so that the engagement surface of the pick-up means is movable and the same pick-up means come into contact with a surface (S1) only of the flexible material (P) and exert on the flexible material (P) a distension force (FD) of a lower intensity than said friction force (FA) while the flexible material (P) is released by the pick-up means with a controlled release speed and is simultaneously positioned on said surface (2), the pick-up member being controlled by a control unit (UC) programmed to control the intensity of the distension force (FD) as a function of the friction coefficient between the engagement surface of the pick-up means and the flexible material and the friction coefficient between the deposition surface (2) and the flexible material (P) and being oriented in a direction opposite to the friction force (FA), and the control unit controls the movement of the first portion of the flexible material (P) with respect to the pick-up means while the same flexible material (P) is released and positioned on said surface (2).

12) Device according to claim 9 characterized in that the friction coefficient between the engagement surface of the pick-up means and the flexible material is higher than the friction coefficient between the deposition surface (2) and the flexible material (P).

13) Device according to claim 9 characterized in that the pick-up member is provided with a surface for engaging the flexible materials which is a surface by means of which the release speed of the flexible material (P) by the pick-up member is controlled, said surface being moved with a predetermined speed along a predetermined release direction during the positioning of the flexible material on the deposition surface (2).

14) (canceled)

15) Device according to claim 9 characterized in that the deposition surface (2) is a mobile surface or a fixed surface.

16) Device according to claim 9 characterized in that in a step of deposition of the flexible material, the pick-up member is moved with a predefined speed (V3) along a direction (D3) opposite to a release direction (DT) of the flexible material by the pick-up member.

17) (canceled)

18) Device according to claim 9 characterized in that it comprises a database (DB) in which a plurality of values of said friction coefficients are stored and the control unit (UC) is connected to the database (DB).

19) Device according to claim 9 characterized in that the pick-up member comprises a frame (35) on which at least two rollers (36) are mounted parallel to each other and enslaved to a corresponding actuator (37) which controls their rotation around the respective longitudinal axes, and on the rollers (36) there is mounted a web (38) closed in a loop on the rollers themselves which, therefore, guide the movement thereof along a direction (DT) orthogonal to a central longitudinal axis of the frame (35) which is engaged on a terminal axis (J6) of a robotic arm (3).

20) Device according to claim 16 characterized in that the pick-up member comprises a frame (35) on which three rollers (36; 36, 36 A, 36B) are mounted, the axes of which are arranged according to a triangular arrangement.

21) Device according to claim 16 characterized in that two rollers (36) are mounted on one side of the frame (35) and two axially aligned rollers (36 A, 36B) are mounted on another side of the frame (36A, 36B) the sum of the whose lengths equals the length of each of the other two rolls (36).

22) Device according to claim 16 in which the web (38) is made up of several elements placed side by side.

23)-25) (canceled)

26) Device according to claim 16 comprising a sensor on the web (38) for detecting, on said web, the presence of the flexible material (P).

27) Device according to claim 9, characterized in that the engagement surface is a flat surface subject to translation in the release phase.

28) Device according to claim 9 characterized in that it comprises means (DV) configured to arrange the flexible materials in a picking position, said means (DV) being arranged and acting at a predetermined point (PP) for picking up the flexible materials and being provided with a spreader element (AD) controlled to spread one side of the flexible materials when preparing them for their picking up, wherein said means (DV) configured for arranging the flexible materials in a picking position are arranged at a picking station (PP) crossed by an overhead conveyor (4) equipped with hangers (40) from which the flexible materials are hung, characterized in that it comprises locking means (200) controlled and configured to temporarily lock the hangers (40) that progressively reach the picking station (PP), said locking means (200) being arranged and acting in the same picking station (PP).

29)-39) (canceled)

40) Device for the automated handling of flexible laminar materials, comprising pick-up means configured to engage a flexible material (P) in correspondence with a contact area of a first free portion of a flexible material with an engagement surface of said pick-up means, and means for moving said pick-up means programmed for moving the pick-up means along a predefined trajectory for depositing a second free portion of the flexible material (P) on a predetermined deposition point (PD) of a predetermined target surface (2) with the development of a frictional force between the flexible material (P) and said surface (2), characterized in that said pick-up means are controlled by a control device programmed such that said pick-up means exert on the flexible material (P) a tension force (FD) of lesser magnitude than said frictional force (FA) while the flexible material (P) is positioned with a controlled release speed on said surface (2), the tension force (FD) being oriented along a direction opposite to the friction force (FA), the control device controls the pick-up means while the same flexible material (P) is released and positioned onto said surface (2) varying the contact area during the release and the deposition of the flexible material onto said surface (2) and the pick-up means comprises a frame (35) on which at least two rollers (36) parallel to each other are mounted and enslaved to a corresponding actuator (37) which controls their rotation around the respective longitudinal axes, and on the rollers (36) there is mounted a web (38) closed in a loop on the rollers themselves which, therefore, guide the movement thereof along a direction (DT) orthogonal to a central longitudinal axis of the frame (35) which is engaged on a terminal axis (J6) of a robotic arm (3).
